(19) United States
(12) Patent Application Publication
(10) Pub. No.: US 2024/0322386 A1
(43) Pub. Date: Sep. 26, 2024

(54) BUS BAR FOR HIGH CURRENT AND BATTERY PACK INCLUDING THE SAME

(71) Applicant: SAMSUNG SDI CO., LTD., Yongin-si (KR)

(72) Inventor: Wonsung KIM, Yongin-si (KR)

(21) Appl. No.: 18/239,163

(22) Filed: Aug. 29, 2023

(30) Foreign Application Priority Data
Mar. 21, 2023 (KR) 10-2023-0036701

(51) Int. Cl. H01M 50/507; H01M 50/503; H01M 50/516; H01M 50/521

(52) U.S. Cl. CPC H01M 50/507; H01M 50/503; H01M 50/516; H01M 50/521

(57) ABSTRACT

Provided are a bus bar for high current and a battery pack including the bus bar, wherein the bus bar includes a connection block including a first metal, and a main body including a second metal different from the first metal and including the connection block attached therein, the connection block and the main body being press-fitted to be shape-matched with each other along a thickness direction of the bus bar.

### CROSS-REFERENCE TO RELATED APPLICATION

This application is based on and claims priority under 35 U.S.C. § 119 to Korean Patent Application No. 10-2023-0036701, filed on Mar. 21, 2023, in the Korean Intellectual Property Office, the disclosure of which is incorporated by reference herein in its entirety.

### BACKGROUND

### 1. Field

One or more embodiments relate to a bus bar for high current and a battery pack including the bus bar. More particularly, embodiments relate to a structure of the bus bar made of metals of different materials.

### 2. Description of the Related Art

As a battery mounted on electric vehicles and hybrid vehicles, etc., a plurality of battery cells may be bus bar-connected to form a battery pack. These battery packs may be characterized by high power and a high energy density. The battery cells that make up the battery pack are mostly lithium-ion batteries, which typically have an anode terminal made of aluminum (Al) and a cathode terminal made of copper (Cu).

As a component for connecting the terminals of a battery cell, a bus bar may be used. A bus bar is a component that is generally used for the distribution of electrical energy.

As shown in FIG. 1, a bus bar 2 may be used to connect battery cells 1 in series and in parallel when the battery cells 1 are configured and modularized. When the terminals of the battery cells 1 are made of aluminum, it is common to also use aluminum as the material of the bus bar 2 for welding. However, in order to use the bus bar 2 made of aluminum for the battery cell 1 with a large amount of current, the thickness or size of the bus bar 2 should be increased. However, increasing the thickness or size of the bus bar 2 runs into limitations such as limited package space and increased manufacturing costs.

To address such limitations, a bus bar made of a dissimilar material of aluminum and copper is disclosed in related arts. A bus bar made of different materials may be constructed by extrusion or drawing, in which one metal is bonded to another metal. However, bus bars manufactured by extrusion or drawing may be expensive to manufacture, and the shape of the bus bar may also be restricted.

### SUMMARY

Embodiments are directed to a current bus bar for high current, including a connection block that includes a first metal; and a main body including a second metal different from the first metal, and surrounding the connection block to include the connection block therein, wherein the connection block and the main body are press-fitted along a thickness direction of the bus bar to be shape-matched with each other.

Additional aspects will be set forth in part in the description which follows and, in part, will be apparent from the description, or may be learned by practice of the presented embodiments of the disclosure.

According to one or more embodiments, a bus bar for high currents includes a connection block including a first metal and a main body including a second metal different from the first metal and surrounding the connection block to include the connection block therein, wherein the connection block and the main body are press-fitted along a thickness direction of the bus bar to be shape-matched with each other.

According to one or more embodiments, one of the first metal and the second metal may include aluminum and the other may include copper.

According to one or more embodiments, the connection block and the main body may be compartmentalized by boundary surfaces that approach each other or move away from each other along a thickness direction of the bus bar.

According to one or more embodiments, the boundary surface between the connection block and the main body may be formed by a side of the connection block and a side of the main body directly contacting each other.

According to one or more embodiments, the connection block and the main body may be formed in a symmetrical shape along the thickness direction of the bus bar with respect to the center of the thickness direction.

According to one or more embodiments, the connection block may include a first connection block and a second connection block, both being formed at both ends along a lengthwise direction forming an electrical connection of the bus bar.

According to one or more embodiments, the first connection block and the second connection block may include, respectively, a pair of first connection blocks and a pair of second connection blocks, both being spaced apart from each other along a widthwise direction intersecting the lengthwise direction of the bus bar.

According to one or more embodiments, the first connection block, the second connection block, and the main body may be formed by press-working the first connection block, the second connection block, and the main body to a certain pressure relative to each other, with blocks of raw material of the first connection block and the second connection block sandwiched therebetween, to conform to profiles formed on the sides of the main body.

According to one or more embodiments, a battery pack provided with a first battery cell connected to the connection block of the bus bar and that has terminals including a first metal of the same type as the connection block may be manufactured.

According to one or more embodiments, the bus bar electrically may connect the first battery cell and a second battery cell neighboring the first battery cell to each other, wherein the terminals of the first battery cell and the terminals of the second battery cell may include a first metal of the same type as the connection block.

The terminals of at least one of the first battery cell and the second battery cell may be connected with leads including a second metal different from the first metal.

According to one or more embodiments, the connection block of the bus bar and the terminal of the first battery cell or the connection block of the bus bar and the terminal of the second battery cell may be connected by laser welding.

### BRIEF DESCRIPTION OF THE DRAWINGS

Features will become apparent to those of skill in the art by describing in detail exemplary embodiments with reference to the attached drawings in which:

FIG. 1 is a diagram illustrating a structure in a battery pack in which a bus bar connects terminals between a plurality of battery cells;

FIG. 2 is a perspective view illustrating a bus bar according to the disclosure;

FIG. 3 is a drawing illustrating the bus bar shown in FIG. 2 connected to a battery cell that make up the battery pack;

FIG. 4 is a drawing illustrating the structure between the connection block and the main body prior to assembly of the bus bar shown in FIG. 2;

FIG. 5 is a drawing illustrating the connection block shown in FIG. 4 coupled to the main body;

FIG. 6 is a diagram illustrating a state in which a bus bar is completed by applying pressure with a mold to the temporary assembly shown in FIG. 5; and

FIG. 7 is a diagram illustrating a terminal connection structure of a battery pack with the bus bar shown in FIG. 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments of the disclosure are described below with reference to the accompanying drawings in such detail as to facilitate practice by one of ordinary skill in the art to which the disclosure belongs. However, the disclosure may be implemented in many different forms and is not limited to the embodiments described herein. In addition, in describing preferred embodiments of the disclosure in detail, specific descriptions of related known features or configurations are omitted where it is determined that such detailed description would unnecessarily obscure the essence of the disclosure. In addition, the same symbols are used throughout the drawings for parts that has similar functions and actions.

To “include” a component means that it can include more components, not that it excludes other components, unless specifically stated to the contrary. Specifically, terms such as “includes” or “has” are intended to designate the presence of a recited feature, number, step, action, component, part, or combination thereof, and are not intended to preclude the possibility of the presence or addition of one or more other features, numbers, steps, actions, components, parts, or combinations thereof.

The singular expression includes the plural unless the context clearly indicates otherwise. In addition, the shapes and sizes of the elements in the drawings may be exaggerated for clarity.

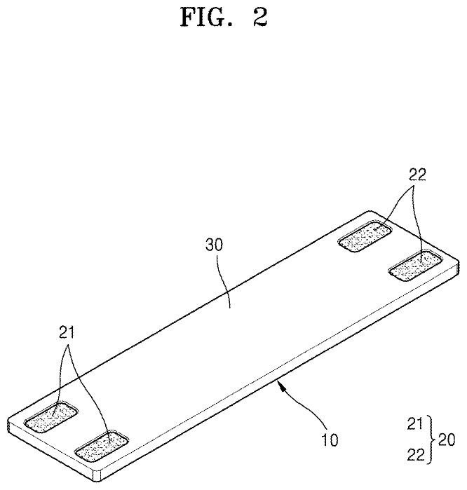

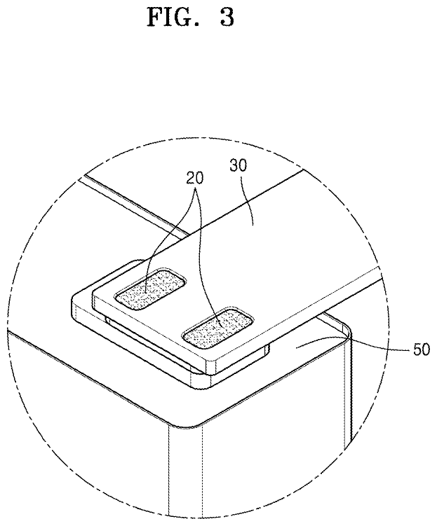

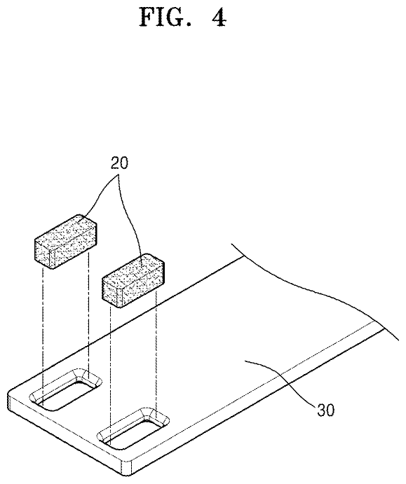

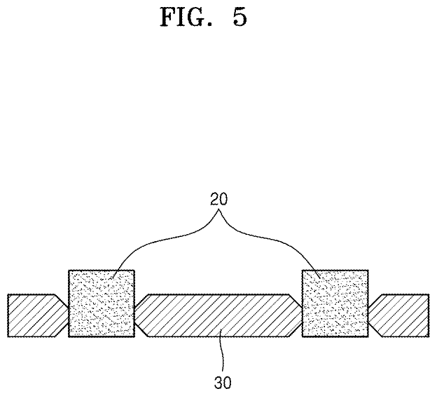

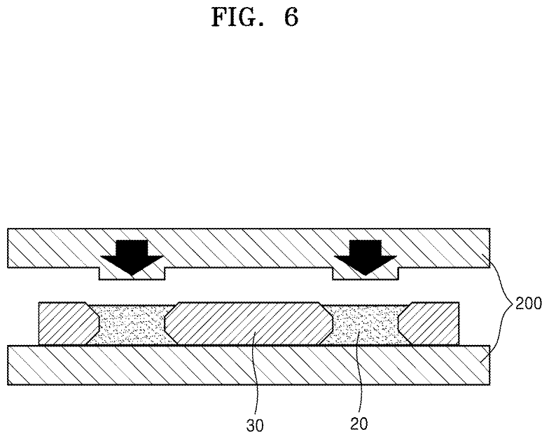

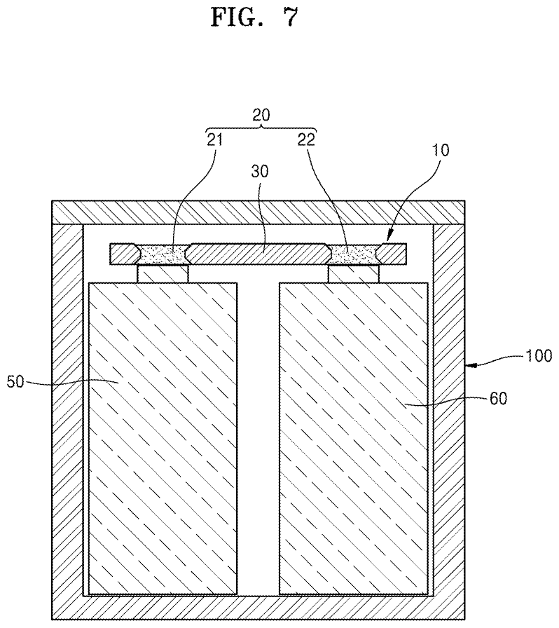

FIG. 2 is a perspective view illustrating a bus bar according to embodiments. FIG. 3 is a drawing illustrating the bus bar shown in FIG. 2 connected to a battery cell that makes up the battery pack. FIG. 4 is a drawing illustrating the structure between the connection block and the main body prior to assembly of the bus bar shown in FIG. 2. FIG. 5 is a drawing illustrating a temporary assembly of the connection block shown in FIG. 4 as coupled to the main body. FIG. 6 is a diagram illustrating a state in which a bus bar is completed by applying pressure with a mold to the temporary assembly shown in FIG. 5. FIG. 7 is a diagram illustrating a terminal connection structure of a battery pack with the bus bar shown in FIG. 2.

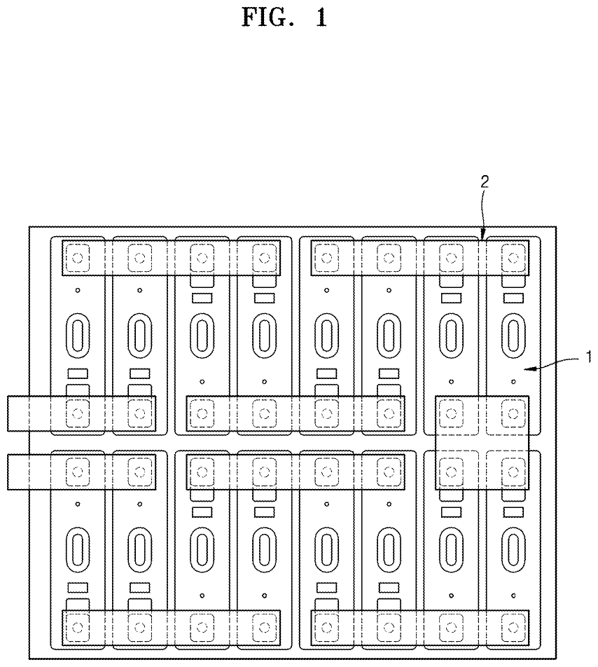

Referring to FIG. 1 to FIG. 7, a bus bar 10 for high current according to the disclosure may include a connection block 20 and a main body 30.

The connection block 20 may be a member including a first metal.

The main body 30 is a member into which the connection block 20 may be embedded. The main body 30 may be configured to enclose the connection block 20. The main body 30 may include a second metal different from the first metal. The main body 30 may be a plate-like member that has a length longer than a width.

The connection block 20 and the main body 30 may be configured to be shape-matched with each other along a thickness direction of the bus bar 10. Herein, the term “shape-matched” may refer to structures having complementary shapes, and/or same thicknesses for example, or where the connection block 20 matches an opening in the main body 30 so as to fill the opening.

One of the first metal and the second metal may include aluminum, and the other of the first metal and the second metal may include copper.

Referring to FIG. 6, the connection block 20 and the main body 30 may be compartmentalized by boundary surfaces that approach or move away from each other along the thickness direction of the bus bar 10.

As shown in FIG. 6, the boundary surface between the connection block 20 and the main body 30 may be formed by a side of the connection block 20 and a side of the main body 30 directly contacting each other.

Referring to FIG. 6, the connection block 20 and the main body 30 may be formed in a symmetrical shape along the thickness direction of the bus bar 10 with respect to the center of the thickness direction. In other words, the upper and lower shapes may be symmetrically configured with respect to a center along the thickness direction of the bus bar 10.

Referring to FIG. 2, the connection block 20 may include a first connection block 21 and a second connection block 22 formed at opposing ends along a lengthwise direction and forming an electrical connection with the bus bar 10. In addition, the first connection block 21 and the second connection block 22 may include, respectively, a pair of first connection blocks 21 and a pair of second connection blocks 22, both being spaced apart from each other along a widthwise direction intersecting the lengthwise direction of the bus bar 10.

The first connecting block 21, the second connecting block 22 and the main body 30 may be assembled by a press-working method. More specifically, the raw material blocks of the first connection block 21 and the second connection block 22 may be temporary assembled in the state shown in FIG. 5 to fit into profiles formed on the sides of the main body 30. Then, with the raw material blocks of the first connection block 21 and the second connection block 22 fitted, a press-work in which the first connection block 21, the second connection block 22 and the main body 30 are pressed at a certain pressure with respect to each other is performed by the mold 200 to complete a mating structure.

Hereinafter, a battery pack 100 that has a bus bar 10 that has the above-described configuration will be described.

Referring to FIG. 7, a first battery cell 50 and a second battery cell 60 may be electrically connected by the bus bar 10. The first battery cell 50 may be provided with terminals including a first metal of the same type as the connection block 20. The terminals of the first battery cell 50 may be connected to the connection block 20 of the bus bar 10.

The bus bar 10 may electrically connect to each other the first battery cell 50 and a second battery cell 60 neighboring the first battery cell 50. The terminals of the first battery cell 50 and the terminals of the second battery cell 60 may include a first metal of the same type as the connection block 20.

The terminals of at least one of the first battery cell 50 and the second battery cell 60 may be connected with leads (not shown) including a second metal different from the first metal. In general, there are instances where different metals are applied to the anode terminal and cathode terminal of the battery cells, in such instances, there may be terminals including a second metal among the terminals of the first battery cell 50 and the terminals of the second battery cell 60.

The connection block 20 of the bus bar 10 and the terminal of the first battery cell 50 or the connection block 20 of the bus bar 10 and the terminal of the second battery cell 60 may be connected by laser welding.

A bus bar including the components as described above and a battery pack including the bus bar may have a structure in which a connection block including a first metal is surrounded by a main body including a second metal that is different from the first metal. The connection block and the main body may be configured to be shape-matched with each other along a circumferential direction of the bus bar, such that the material between the connection block and the electricity-conducting main body of the bus bar for high current might be different. Thus, the bus bar may have the advantage that the having the same shape of the bus bar as the related shape may be useful for high current. Accordingly, it may be possible to manufacture a battery pack for high current without limiting the package space.

In addition, the bus bar according to the disclosure may have the advantage that the bus bar may be manufactured without the use of extrusion equipment or roller equipment, and can efficiently adapt to bus bars with various structures, compared to bus bars that are manufactured by related extrusion or cladding methods, due to a high degree of freedom in the application structure of the connection block.

While the disclosure has been described in detail with reference to a preferred embodiment, it is apparent that the disclosure is not limited to the above embodiment and that many modifications are possible within the technical ideas of the disclosure by one of ordinary skill in the art.

The bus bar according to embodiments may have a structure in which a connection block including a first metal is surrounded by a main body including a second metal different from that of the first metal The connection block and the main body may be configured to be shape-matched with each other along a circumferential direction of the bus bar, such that the material between the connection block and the electricity-conducting main body of the bus bar for high current may be different from each other. Thus, there may be an advantage that the same shape of the bus bar as the related shape may be used for high current. Accordingly, it may be possible to manufacture a battery pack that can be used for high current without limiting the package space.

It is to be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A current bus bar for high current, including:
a connection block including a first metal; and
a main body including a second metal different from the first metal, and surrounding the connection block to include the connection block therein,
wherein the connection block and the main body are press-fitted along a thickness direction of the bus bar to be shape-matched with each other.

2. The bus bar for high current as claimed in claim 1,
wherein one of the first metal and the second metal include aluminum and the other includes copper.

3. The bus bar for high current as claimed in claim 1,
wherein the connection block and the main body are compartmentalized by boundary surfaces approaching each other or moving away from each other along the thickness direction of the bus bar.

4. The bus bar for high current as claimed in claim 1,
wherein a boundary surface between the connection block and the main body is formed by a side of the connection block and a side of the main body directly contacting each other.

5. The bus bar for high current as claimed in claim 1,
wherein the connection block and the main body are formed in a symmetrical form with respect to a center of the thickness direction along the thickness direction of the bus bar.

6. The bus bar for high current as claimed in claim 1,
wherein the connection block includes a first connection block and a second connection block, both being located at opposite ends along a lengthwise direction forming an electrical connection of the bus bar.

7. The bus bar for high current as claimed in claim 6,
wherein the first connection block and the second connection block include a pair of first connection blocks and a pair of second connection blocks, respectively, both being spaced apart from each other along a widthwise direction intersecting the lengthwise direction of the bus bar.

8. The bus bar for high current as claimed in claim 6, wherein the first connection block, the second connection block, and the main body are formed by press-working the first connection block, the second connection block, and the main body to a predetermined pressure relative to each other, with blocks of raw material of the first connection block and the second connection block being sandwiched therebetween to fit into a profile formed on a side of the main body.

9. A battery pack including the bus bar as claimed in claim 1,
and further including a first battery cell connected to the connection block of the bus bar and including a terminal comprising a first metal of a same type as the connection block.

10. The battery pack as claimed in claim 9,
wherein the bus bar electrically connects the first battery cell and a second battery cell neighboring the first battery cell to each other, and the terminal of the first battery cell and a terminal of the second battery cell include the first metal of a same type as the connection block.

11. The battery pack as claimed in claim 10,
wherein the terminals of at least one of the first battery cell and the second battery cell are connected with leads including a second metal different from the first metal.

12. The battery pack as claimed in claim 10,
wherein the connection block of the bus bar and the terminal of the first battery cell or the connection block of the bus bar and the terminal of the second battery cell are connected to each other by laser welding.
